(19) United States
(12) Patent Application Publication
(10) Pub. No.: US 2003/0037285 A1
(43) Pub. Date: Feb. 20, 2003

(54) Signal processor and apparatus for reproducing information

(76) Inventors: Charalampos Pozidis, Gattikon (CH); Willem Marie Julia Marcel Coene, Eindhoven (NL); Johannes Wilhelmlus Maria Bergmans, Eindhoven (NL)

Correspondence Address: U.S. Philips Corporation, 580 White Plains Road, Tarrytown, NY, 10591, US

(21) Appl. No.: 10/140,508

(22) Filed: May 7, 2002

(30) Foreign Application Priority Data
May 10, 2001 (EP) 01201710.9

(51) Int. Cl. G06F 11/00

(52) U.S. Cl. 714/15

(57) ABSTRACT

The signal processor (5) for converting a read signal into a bit-stream, and correcting runs in that bit-stream which violate a minimum run length constraint. The signal processor (5) comprises a preliminary detector (51) able to convert a read signal read out from a recording medium (1) into a bit-stream. The signal processor (5) further comprises a violation detector (52) able to detect a first violating run Rv violating a minimum run length constraint in the bit-stream. Also, the signal processor (5) comprises a correction means (53) able to correct a first violating run Rv by toggling a bit chosen from a first bit in a first direction, and a second bit in a second direction. The correction means (53) is further able to correct subsequent violating runs Rv that are created as a result of the correction of the first violating run Rv. The correction means (53) may be able to use tangential tilt information to decide in which direction the corrections are made.

Further the apparatus for reproducing information recorded on an information carrier (1), the apparatus uses the signal processor (5) of the invention has an improved bit error rate.

The invention relates to a signal processor, comprising:

a preliminary detector able to convert a read signal read out from a recording medium into a bit-stream;

a violation detector able to detect a run Rv violating a minimum run length constraint in the bit-stream;

a corrections means able to correct a first violating run Rv by toggling a bit chosen from a first bit in a first direction, immediately preceding and a second bit in a second direction, immediately following the violating run Rv.

The invention also relates to an apparatus for reproducing information recorded on an information carrier having such a signal processor.

Such a signal processor is known from EP-A-0 821 360.

The known signal processor is designed to use instantaneous amplitudes of samples of said read signal corresponding to the first and the second bit, to correct the violating run Rv by toggling a bit chosen from the first bit and the second bit, if the violating run has a run length of the minimum run length minus one. If the violating run has a run length of the minimum run length minus two, then both the first bit and second bit are toggled.

Toggling hereinafter means changing the value of a bit from +1 to −1, or from −1 to +1.

The signal processor is used in Run Length Limited codes. In these codes there is a constraint on the maximum and minimum number of successive bits with the same value, +1 or −1, the successive bits with the same value are referred to as runs. These constraints are indicated by the parameters d and k. In order to understand these parameters, first an explanation will be given of an other way to represent data. Data can also be represented by values 0 and 1, the 0 representing no change in respect to the previous bit, the 1 representing a change in respect to the previous bit. In this context the parameter d stands for the minimum number of successive 0's, thus the minimum number of successive bits +1 or −1 is d+1. The parameter k indicates the maximum number of successive 0's, thus the maximum number of successive bits +1 or −1 is k+1. For instance, a run length limited code were d=2 indicates a run length constraint of three, so a minimum number of successive bits, with the same value of +1 or −1, is three.

The known signal processor has the disadvantage that the bit-stream at the output of this signal processor still has a relatively high bit error rate. When a minimum run Rm with minimum run length is adjacent to the first violating run Rv, and if the correction is carried out by toggling a bit from said minimum run Rm, then a new violating run Rv occurs. This new violating run Rv is not corrected by the known signal processor. An even worse situation occurs when a train of n minimum runs Rm is adjacent to the first violating run Rv, and correction proceeds towards the train. Not only a bit adjacent to the first violating run Rv has to be toggled, but also a respective bit adjacent to all the minimum runs Rm of the train in the same direction. This is because, provided the decision to correct towards the train is correct, the respective bits adjacent to all the minimum runs Rim are detected faulty. In this situation n errors are present in the train. Added to the error of the first violating run Rv this makes n+1 errors. So n+1 bits have to be toggled. The known signal processor toggles only one bit, leaving n errors behind. If the known signal processor would carry out another correction operation on the data, only one error is detected and subsequently corrected. Still n−1 errors are left. In order to correct all errors, n+1 iterations have to be performed. Each correction operation takes some time, because each time a decision has to be made to correct the first bit or the second bit. Moreover, it is not sure that eventually all errors are corrected. If the correction started in a first direction, it is possible that before the last correction of the train is made, the processor decides to correct a violating run Rv in the second direction. This leads to a very time consuming iterative operation.

It is a first object of the invention to provide a signal processor of the kind described in the opening paragraph the output of which has a relatively low bit error rate, and yet the signal processor has a relatively high operating speed at which the corrections can be made.

It is a second object of the invention to provide an apparatus for reproducing information recorded on an information carrier, which is provided with such a signal processor.

The first object is realized in that said correction means is designed to correct additional violating runs Rv which are created as a result of correcting the first violating run Rv, by toggling a respective bit adjacent to the additional violating runs in the same direction as the direction at which the new violating run is located with respect to the first violating run. The signal processor of the invention not only toggles a bit adjacent to the first violating run Rv, but if the bit which is toggled to correct the first violating run Rv belongs to a minimum run Rm, also toggles a bit adjacent to that minimum run Rm. The new violating run Rv that results from toggling said bit of said minimum run Rm, is corrected by toggling a bit neighboring said new violating run Rv in the same direction. The bit that is toggled to correct the new violating run Rv is in the same direction as the bit toggled to correct the first violating run Rv. So if the signal processor corrects the first violating run Rv by toggling a first bit in a first direction, and that bit is part of a minimum run Rm, then also a bit adjacent to the minimum run Rm in the first direction, is toggled.

When a train of minimum runs Rm is adjacent to the first violating run Rv, the signal processor corrects errors by toggling adjacent bits of minimum runs Rm of that train. The signal processor is designed to make all these corrections in one operation. The effect that not only a bit is toggled to correct the first violating run Rv, but also adjacent bits to minimum runs Rm, is further referred to as the domino effect. Only when the first violating run Rv is corrected, a decision is made in which direction to correct the first violating run Rv, the subsequent corrections are made in the same direction. Therefore the whole correction operation takes up less time then the described iterative operation of the known processor. In the second direction, following the first violating run Rv, all the minimum runs Rm of a train of minimum runs Rm can be corrected, leaving no errors behind. Normally, also in the first direction, preceding the violating run Rv, all the minimum runs Rm of a train can be corrected. In the first direction a train of minimum runs Rm is stored in a, e.g. external, data buffer. The data buffer is used by the signal processor in order to be able to correct runs that already passed the signal processor. The data buffer has a finite capacity, and can therefore hold a limited amount of runs. Generally, only in extreme situations the number of runs of a train exceeds the capacity of the buffer.

It is advantageous if the correction means is designed to use tangential tilt information to correct the first violating run Rv, and the said additional violating runs Rv. When the decision to toggle a bit chosen from a first bit and a second bit, is based on instantaneous amplitudes of samples corresponding to the first bit and second bit, as is the case in the known signal processor, random fluctuations, like noise, have a big influence on the decision. If a wrong decision is made, then more errors occur when toggling bits of a train of minimum runs Rm. In the event that more than one error occurs in successive runs, it is apparent that the source of the errors is not random noise. Some of the main distortions in e.g. an apparatus for reproducing information recorded on an optical disc tend to affect said read signal in a systematic way. An example of such a distortion is tangential tilt of a disk. Tangential tilt modifies the optical impulse response in an asymmetric manner, and as such introduces errors in an output of the preliminary detector in a predefined way. In the presence of tangential tilt, a first bit of a minimum run Rm has an amplitude other than a last bit of the minimum run Rm. This is a result of the asymmetrical impulse response. It is therefore obvious that the bit with a lower corresponding absolute amplitude is likely to be faulty detected, and must be toggled. If more than one error occurs in successive runs, then tangential tilt is likely to be the source of the errors. So using tangential tilt information to correct the first violating run Rv, and the additional violating runs Rv, improves the bit error rate.

In a favorable embodiment the correction means is designed to derive the tangential tilt information from a first average absolute amplitude based on amplitudes of samples of said read signal corresponding to an immediately preceding bit of, and a second average absolute amplitude based on amplitudes of samples of said read signal corresponding to an immediately following bit of previous violating runs Rv already detected by the violation detector. No extra component like a tangential tilt sensor is needed. The ratio behind this decision is that tangential tilt causes a systematic difference between the average absolute amplitude of samples of said read signal corresponding to the respective immediately preceding bits and to the respective immediately following bits of violating runs Rv. Of course, this last remark is with respect to detected runs, not with respect to the original data on the information carrier. The original data does not have any violating runs Rv.

It is advantageous if said average absolute amplitudes are the average absolute amplitudes of a predetermined number of samples. As mentioned in a previous paragraph, the first and the second average absolute amplitudes give an indication of the tangential tilt. When using a predetermined number of samples, the tangential tilt is determined locally, i.e. in the area where the information is read. This is advantageous because the tangential tilt can vary depending on the location of the information on the information carrier. When using limited number of samples, the correction means adapts quicker to tangential tilt variations.

It is favorable if the signal processor that has a correction means that uses tangential tilt information to correct the first violating run Rv, has the provision that if the first violating run Rv is bordered by runs having a run length longer than the minimum run length, then the correction means is able to make a decision between correcting by toggling the first bit and by toggling the second bit, using instantaneous amplitudes of samples of said read signal corresponding to adjacent bits of the first violating run Rv as parameters of the decision. Minimum runs Rm have an effect on surrounding minimum runs Rm in that the absolute amplitude of bits surrounding the minimum run Rm is reduced. This effect is called Inter Symbol Interference. If, for instance, a first minimum run Rm is followed by a second minimum run Rm, and there is a substantial tangential tilt, then the absolute amplitude of the last bit of the first minimum run Rm may be reduced and in fact cross a level at which the bit is detected faulty. This affect is similar when a first minimum run Rm is preceded by a second minimum run Rim, accept in that case the first bit of the first minimum run Rm has a reduced absolute amplitude. If a minimum run Rm is followed by a run longer than the minimum run length, the probability that the minimum run Rm becomes a violating run Rv as a consequence of tangential tilt is reduced. Furthermore, if a first violating run Rv is bordered by a minimum run Rm, than it is probable that more than one error has occurred. It is likely that the bit that has to be toggled is a bit from the minimum run Rm. But then it is obvious that this is not the only error in the bit-stream, because the minimum run Rm becomes a violating run Rv itself. Thus, also an adjacent bit in the same direction is toggled, which must be a second error in the bit-stream. In case of a plurality of errors following each other, it is probable that the errors are created by a systematic disturbance like tangential tilt. If a first violating run Rv is bordered by runs having a run length longer than the minimum run length, the probability that the error occurred as a consequence of tangential tilt, is smaller as is in the case of bordering minimum runs Rm. The probability that the error occurred from a random error like noise is increased. Therefore the instantaneous amplitudes are used to make the correction.

A further modification of the signal processor wherein the correction means uses the average amplitudes to derive tangential tilt information, is as follows. When the first violating run Rv is bordered by a minimum run Rm, and if an absolute difference between the first average absolute amplitude, and the second average absolute amplitude is greater than a threshold value, then the correction means is able to choose between toggling the first bit and the second bit, using said average values, using instantaneous amplitudes otherwise. If said absolute difference is greater than a threshold value, then the tangential tilt most probably exceeds a predetermined value. In this case, when the tangential tilt exceeds said predetermined value, the probability of errors being caused by the tangential tilt is relative high. Then it is also probable that the error occurred as a result of the tangential tilt. Hence, a correction on the basis of said absolute values is relatively reliable in that case. If the first violating run Rv is not bordered by a minimum run, then the influence of tangential tilt is reduced. In that case the instantaneous amplitudes are used.

The second object of the invention is realized in that the apparatus for reproducing information recorded on an information carrier, is provided with the signal processor according to the invention.

Such an apparatus generally also comprises:

a read head able to read information from a record carrier;

a displacement means able to cause a relative displacement between the information carrier and the read head;

a pre-processing unit able to process the signal coming from the read head to a read signal better suitable for further processing;

a channel decoding means able to decode the created bit-stream;

a buffer able to store runs of the bit-stream.

The apparatus for reproducing information recorded on an information carrier which uses the signal processor according to the invention has an improved bit error rate. Furthermore it can operate at a relatively high speed, because said signal processor has a high operating speed.

These and other aspects of the signal processor and the apparatus for reproducing information according to the invention will be apparent from and be elucidated by means of the drawings, in which:

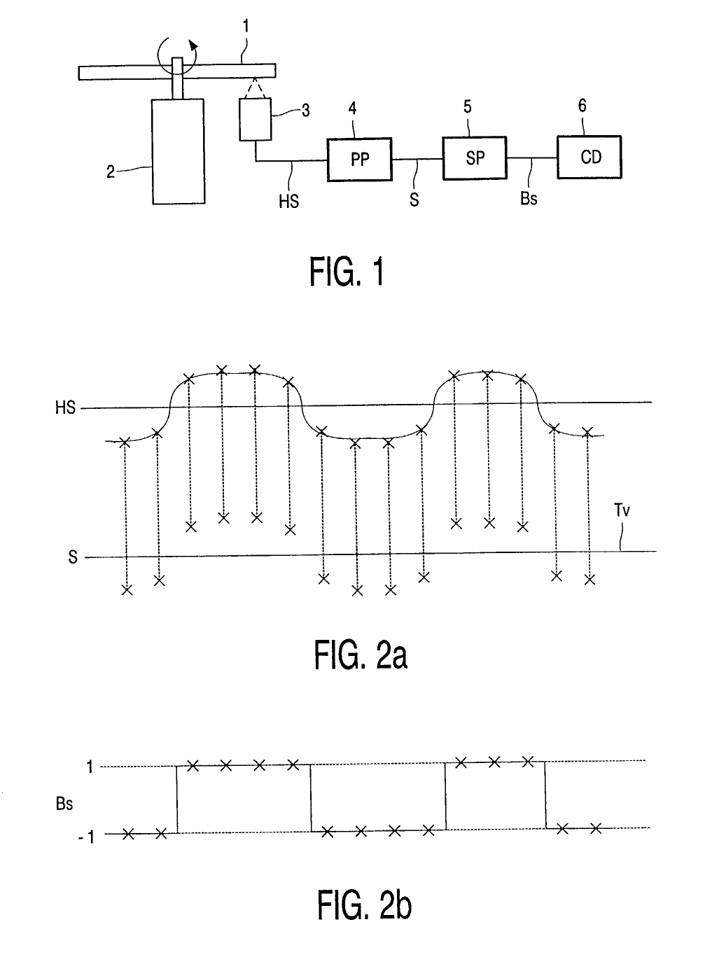

FIG. 1 shows schematically the recorded information reproducing apparatus having the signal processor;

FIG. 2a shows an example of the result of the process of sampling a read signal S;

FIG. 2b shows an example of the result of the process of converting the samples of the read signal S into a bit-stream;

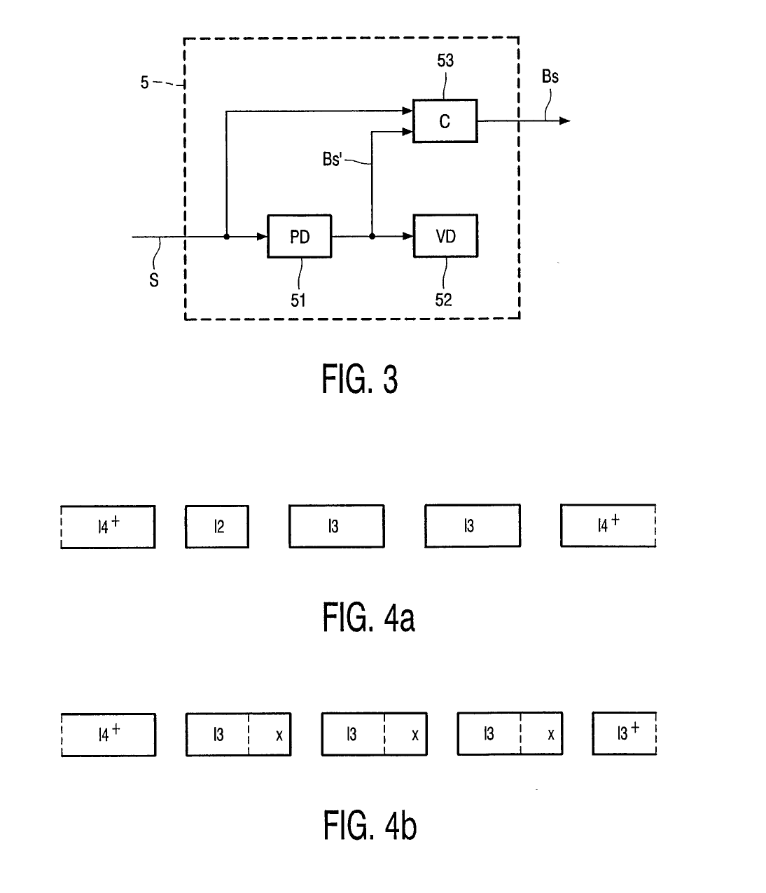

FIG. 3 shows an embodiment of the signal processor;

FIG. 4a shows an example of a bit-stream with a violating run Rv;

FIG. 4b shows an example of the bit-stream of FIG. 4a after the signal processor has corrected the violating run Rv;

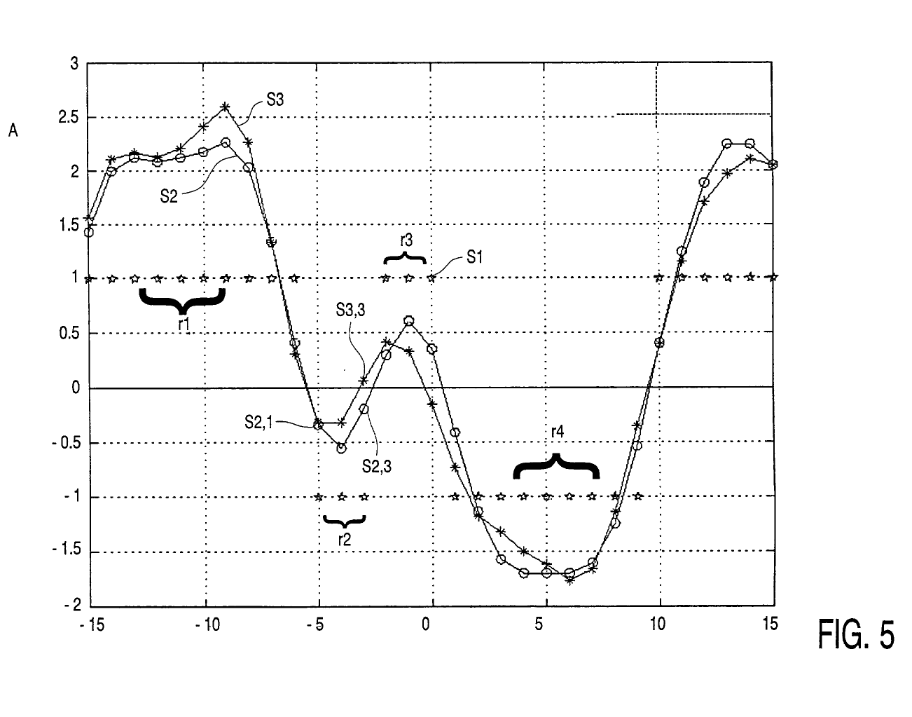

FIG. 5 shows an example of read signals in the presence of 0 degrees tangential tilt and 0.7 degrees tangential tilt;

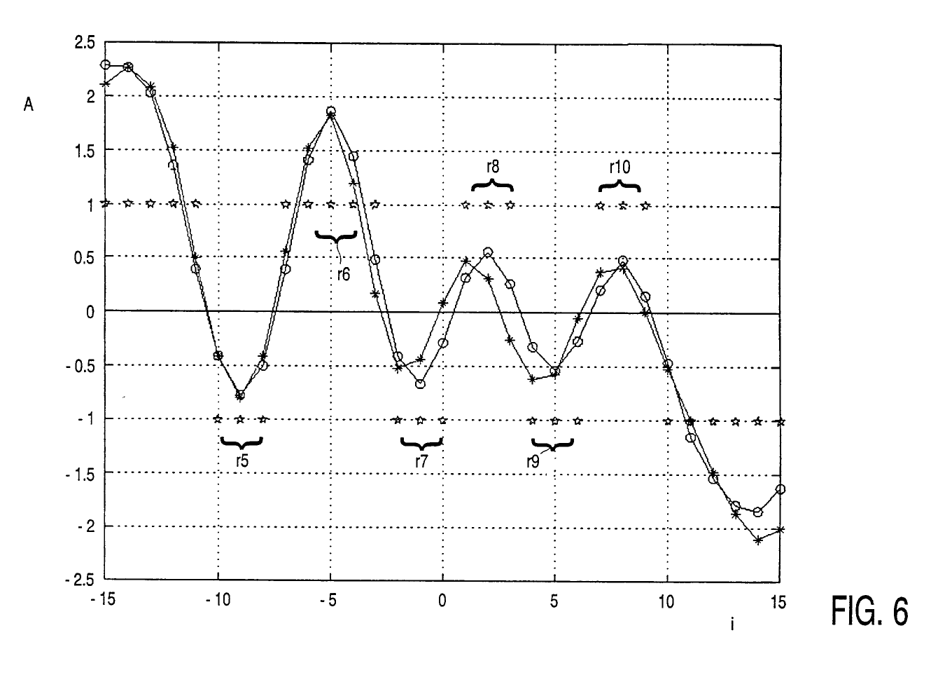

FIG. 6 shows an other example of read signals in the presence of 0 degrees tangential tilt and 0.7 degrees tangential tilt;

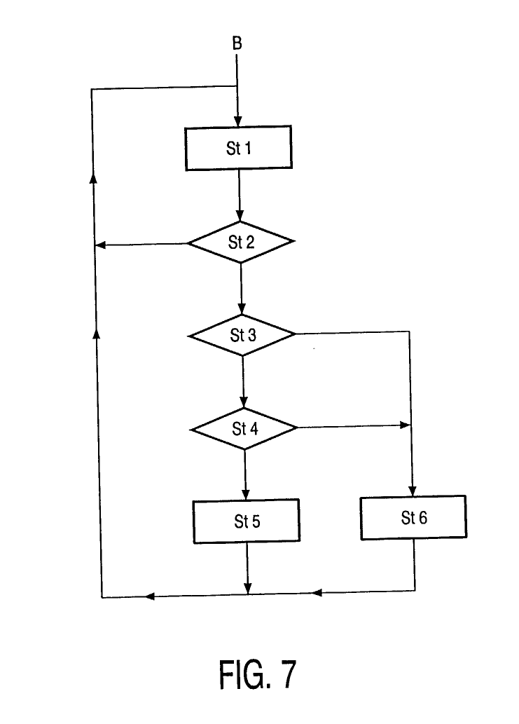

FIG. 7 shows a decision tree of an embodiment of the signal processor.

In FIG. 1 the apparatus comprises a read head 3 for reading the information from an information carrier 1. A displacement means 2 is able to cause a relative displacement between the information carrier 1 and the read head 3. An output of the read head 3, the analog head signal HS, is fed to a pre-processor 4. This pre-processor 4 samples the input on discrete moments in time and also converts the input to a signal, read signal S, suitable for further processing. Typically the pre-processor 4 amplifies, samples and equalizes the input resulting in a read signal S. The read signal S is an input of a signal processor 5. The signal processor 5 is able to convert said read signal S into a bit-stream Bs. The bit-stream Bs is further decoded by the channel decoding means 6.

A simple embodiment of a signal processor 5 is a threshold detector. A threshold detector compares an amplitude of the samples of said read signal with a threshold value. If the amplitude is greater than the threshold value, the threshold detector outputs a bit with value 1. If the amplitude is smaller than the threshold value, the threshold detector outputs a bit with value −1. In FIG. 2a an example is shown of the result of the process of converting an analog head signal HS into the read signal S which contains samples of said head signal HS. This operation is performed by the pre-processor 4. Next, the samples are converted into a bit-stream Bs by the threshold detector, the result of this process is shown in FIG. 2b. Here clearly a bit has a value 1 if a corresponding sample of the read signal has an amplitude higher than the threshold value Tv. In the same way, a bit has a value −1 if a corresponding sample of the read signal has an amplitude lower than the threshold value Tv. ‘Corresponding’, in this context, means that a bit in the output of the threshold detector ‘corresponds’ to a sample of the read signal, if the detector used the amplitude of that sample to determine the value of that bit.

An embodiment of a signal processor 5 of the invention is depicted in FIG. 3. The read signal S is an input of a preliminary detector 51. This detector 51 is able to convert a read signal S into a bit-stream Bs'. This may be done in a same way as said threshold detector does. There are however other kinds of detectors for converting the read signal S into a bit-stream Bs'.

A violation detector means 52 is able to detect if there is a runs in the bit-stream which violates a minimum run length constraint. If a run is violating the minimum run length constraint, then the correction means 53 is able to correct a first violating run Rv by toggling a bit chosen from a first bit in a first direction, immediately preceding, and a second bit in a second direction, immediately following the first violating run Rv. The choice between toggling the first and second bit does not have to be made if the first violating run Rv is two bits smaller than the minimum run length. In that case it is obvious that both surrounding bits have to be toggled. Of course, when using a code which has a run length constraint of two and the two bits are detected faulty, then no violating run Rv is detected and there is no correction.

If the first violating run Rv has a run length of the minimum run length minus one, then the correction means is able to make a choice between correcting in the first direction and in the second direction. If as a result of correcting the first violating run Rv in a direction a second violating run Rv is created, then the correction means 53 is able to correct the second violating run Rv by toggling an adjacent bit in the same direction. The correction means 53 is furthermore able to correct additional violating runs Rv which are created as a result of correcting the first violating run Rv, by toggling an adjacent bit of the corresponding run in the same direction.

In the example of FIG. 4a a minimum run length constraint of three is assumed. In this FIG. ‘Iₙ’ stands for a run with a length of n bits, ‘Iₙ+’ stands for a run with a run length of n bits or more. In the bit-stream a first violating run Rv, indicated by I₂, is detected. A decision is made to correct the first violating run Rv in the second direction, following the first violating run Rv. In FIG. 4b the bit-stream is shown after the correcting means 53 with the domino effect has corrected the first violating run Rv and additional violating runs Rv. The bit that is toggled in the second direction is indicated by an x. Because the next run following the first violating run Rv has a minimum run length (I₃), this minimum run Rm becomes a second violating run Rv. Thus the correction means 53 will also toggle a bit immediately following the second violating run Rv to cancel this violation. This again results in a third violating run Rv. As a result a bit immediately following the third violating run Rv is toggled. The next run is longer than the minimum run length, thus no more violating runs Rv are created. As a result the last run is reduces in bit length by one.

The number of additional created violating runs Rv that can be corrected in the second direction is indefinite. If the first violating run Rv is followed by a train of minimum runs Rm, then the correction means 53 can correct all additional created violating runs Rv. In the first direction normally also all additional created violating runs Rv can be corrected. Because those runs have already passed the signal processor 5, a train of runs that have a minimum run length has to be stored in a buffer in order to correct all the additionally created violating runs Rv in the first direction. Because a buffer has a finite capacity, there is a limit to the number of minimum runs Rm that can be corrected. In normal operation the amount of successive minimum runs Rm is limited, and consequently all the additional created violating runs Rv are corrected. In some coding schemes there is a constraint on the maximum number of minimum runs Rm that can succeed each other. In these schemes the signal processor 5 has no limitation in the first direction.

It is also possible that both of the bits surrounding the violating run Rv, have to be toggled. This is the case for instance when the first violating run Rv has a run length that is equal to the minimum run length minus two. In that case the correction means 53 is able to correct additional created violating runs Rv, in two directions. The correction means 53 does not have to decide which direction to correct, because both the first bit and the second bit have to be toggled. This of course does not hold for a code with a run length constraint of two. In the case that the violating run Rv has a length of the minimum run length minus two, the violation detector 52 does not detect a violation.

In FIG. 5 the unit of the vertical axis is the amplitude A of the signals, the unit of the horizontal axis is the sample number i. One signal S2, indicated by 's, shows a read signal S when no tangential tilt is present. Another signal S3, indicated by 's, shows a read signal in the presence of tangential tilt of 0.7 degrees. The signal S1 shows the data that was originally on the information carrier 1, indicated by 's. In this example again a minimum run length of three is assumed. The second run r2 in FIG. 5 is a minimum run Rm. The amplitudes of the samples of signal S2 corresponding to that minimum run Rm show a relatively symmetrical variation in time. In case that a tangential tilt is present however, a signal S3 with an asymmetrical variation in time results. The last bit of the minimum run Rm exceeds the threshold and will be detected as a 1. The original bit-pattern is (I₁₀+)−(I₃)−(I₃)−(I₉), but the bit-pattern of the signal S3 will be detected as (I₁₀+)−(I₂)−(I₃)−(I₁₀). It is determined that from the two bits surrounding a detected first violating run Rv I₂, the bit which crosses the threshold as a result of tangential tilt, has a lower average absolute value of a corresponding sample of the read signal S. In this case where the tangential tilt is +0.7 degrees, an immediately following bit has a lower corresponding average absolute amplitude than an immediately preceding bit. In the presence of a tangential tilt of −0.7 degrees, the immediately preceding bit has a lower corresponding average absolute amplitude than the immediately following bit. Of course, the definition of positive or negative tangential tilt may differ, in that case the influence on the amplitudes of the bits is the other way round.

A favorable embodiment of the signal processor 5 is the signal processor 5 of FIG. 3 wherein the correction means 53 is designed to use tangential tilt information to correct the first violating run Rv, and the said additional violating runs Rv.

It is furthermore favorable that the signal processor 5 of FIG. 3 is able to derive the tangential tilt information from a first average absolute amplitude based on amplitudes of samples of said read signal corresponding to an immediately preceding bit of, and a second average absolute amplitude based on amplitudes of samples of said read signal corresponding to an immediately following bit of, previous violating runs Rv already detected by the violation detector. An adjacent bit will be toggled in the direction that corresponds to the position of the smaller average absolute amplitude.

A tangential tilt can be dependent on a position of the read head. The tangential tilt can vary during reading of the information carrier. A signal processor 5 of FIG. 3 characterized in that said average absolute amplitudes are the average absolute amplitudes of a predetermined number of samples, can perform better in such a situation. Because only a limited number of samples is used to determine the tangential tilt, the tangential tilt is determined locally. There is an optimum in the number of samples to be taken. If too few samples are taken, the average absolute amplitudes become more sensitive to random fluctuations like noise. If too many samples are taken, the average absolute amplitudes are not sensitive enough to changes in the tangential tilt. In an implementation of the signal processor 5 an adaptive mechanism can be used. An example is shown in equation 1.

Equation 1

$$\overline{{A}_{1}} = α \overline{ {A}_{1}} + ( 1 - α ) {A}_{1}$$

$$\overline{{A}_{2}} = α \overline{ {A}_{2}} + ( 1 - α ) {A}_{2}$$

Where,

A₁ stands for the absolute value of the instantaneous amplitude of a sample corresponding to the bit adjacent to the violating run Rv in the first direction,

A₂ stands for the absolute value of the instantaneous amplitude of a sample corresponding to the bit adjacent to the violating run Rv in the second direction,

$$\frac{\overline{{A}_{1}}}{{A}_{2}}$$

stands for the average weighted value of A₁,

stands for the average weighted value of A₂, and

α is a constant controlling the adaptation speed, or bandwidth, of the adaptive mechanism.

If α is taken relatively small, then the adaptive mechanism is adapting relatively quickly. If α is taken relatively large, then the adaptive mechanism is adapting relatively slowly. Here an optimum value of α lies in between.

In FIG. 5 it can be seen from signal S2 that the sample S2,3 corresponding to the last bit of the first minimum run Rm has a lower absolute amplitude then the sample S2,1 corresponding to the first bit. This is caused by an Inter Symbol Interference effect. The second minimum run Rm influences the first minimum run Rm. In the presence of tangential tilt the last bit S3,3 passes the threshold value. If a minimum run Rm is bordered by runs having a run length longer than the minimum run length, then there is less Inter Symbol Interference. The corresponding samples of the bits of the minimum run length have a relative high absolute amplitude. This is shown in FIG. 6. The units and indications are the same as in FIG. 5. Thus the signal with zero degrees tangential tilt is indicated by 's, the signal with 0.7 degrees tangential tilt is indicated by 's, and the original data by 's. In FIG. 6 the first minimum run r5 is surrounded by runs having a length longer than the minimum run length. Furthermore, the influence of tangential tilt on the first minimum run Rm is small. If a first violating run Rv is detected which is bordered by runs longer than the minimum run length, then the error was probably created by random effects like noise. For this reason the signal processor 5 of FIG. 3 of an other embodiment uses instantaneous amplitudes of samples corresponding to adjacent bits of the first violating run Rv as parameters of the decision as to which adjacent bit to toggle.

FIG. 7 shows a decision tree of an other embodiment of a signal processor 5 of FIG. 3. Beginning from point B, the first step St 1 loads a run in a buffer. The next step St 2 checks if this run is a first violating run Rv. If this run is a first violating run Rv, then the next step is St 3, otherwise the next step is St 1 again. In St 3 the absolute difference between a value AAL and a value AAR is compared with a threshold value. AAL stands for average absolute amplitude of a sample corresponding to a bit immediately left of the first violating run Rv. AAR then stands for average absolute amplitude of a sample corresponding to a bit immediately right of the first violating run Rv. If this difference is greater than the threshold value, then the next step is St 4, otherwise the next step is St 6. In St 4 the correction means 53 checks if the first violating run Rv is bordered by a minimum run Rm. If that is the case, the next step is St 5, otherwise the next step is St 6. In St 5 the amplitudes AAL and AAR are used to choose between correcting in the first direction and in the second direction. The correction proceeds in the first direction if AAL is smaller than AAR, and in the second direction if AAL is greater than AAR. In St 6 instantaneous amplitudes of the samples corresponding to the left and right bit are used. In conclusion instantaneous amplitudes are used in two cases. The first case occurs if the first violating run is not bordered by a minimum run. In this case the tangential tilt has little influence. The second case occurs if the absolute difference between AAL and AAR is not greater than a predetermined threshold value. In that case it can be concluded that there is no or little tangential tilt. Therefore tangential tilt information does not contribute to a correct decision in which direction to make the corrections.

Now that the signal processor 5 and the apparatus of the invention have been described with reference to several embodiments thereof, it is to be understood that the embodiments are not limitative examples. Thus, various modifications may become apparent to those skilled in the art, without departing form the scope of the invention, as defined in the claims. Further, the invention lies in each and every feature and combination of features.

1. Signal processor (5), comprising:
a preliminary detector (51) able to convert a read signal read out from a recording medium into a bit-stream;
a violation detector (52) able to detect a run Rv violating a minimum run length constraint in the bit-stream;
a corrections means (53) able to correct a first violating run Rv by toggling a bit chosen from a first bit in a first direction, immediately preceding, and a second bit in a second direction, immediately following the first violating run Rv,
characterized in that said correction means (53) is designed to correct additional violating runs Rv which are created as a result of correcting the first violating run Rv, by toggling a respective bit adjacent to the additional violating runs Rv in the same direction as the direction at which the new violating run is located with respect to the first violating run.

2. A signal processor (5) as claimed in claim 1, characterized in that the correction means (53) is designed to use tangential tilt information to correct the first violating run Rv, and the said additional violating runs Rv.

3. A signal processor (5) as claimed in claim 2, characterized in that the correction means (53) is designed to derive the tangential tilt information from a first average absolute amplitude based on amplitudes of samples of said read signal corresponding to an immediately preceding bit of, and a second average absolute amplitude based on amplitudes of samples of said read signal corresponding to an immediately following bit of previous violating runs Rv already detected by the violation detector (52).

4. A signal processor (5) as claimed in 3, characterized in that said average absolute amplitudes are the average absolute amplitudes of a predetermined number of samples.

5. A signal processor (5) as claimed in claim 2, characterized in that if the first violating run Rv is bordered by runs having a run length longer than the minimum run length, then the correction means (53) is able to make a decision between correcting by toggling the first bit and by toggling the second bit, using instantaneous amplitudes of samples of said read signal corresponding to adjacent bits of the first violating run Rv as parameters of the decision.

6. A signal processor (5) as claimed in claim 3, characterized in that if the first violating run Rv is bordered by a minimum run, and if an absolute difference between the first average absolute amplitude, and the second average absolute amplitude is greater than a threshold value, then the correction means (53) is able to choose between toggling the first bit and the second bit, using said average values, using instantaneous amplitudes otherwise.

7. An apparatus for reproducing information recorded on an information carrier (1), provided with a signal processor (5) as claimed in claim 1.
